(19) United States
(12) Patent Application Publication
(10) Pub. No.: US 2025/0387762 A1
(43) Pub. Date: Dec. 25, 2025

(54) MULTILAYER SOL-GEL GREEN CERAMIC MEMBRANE AND USES THEREOF

(71) Applicants: PETRÓLEO BRASILEIRO S.A. - PRETROBRAS, Rio de Janeiro (BR); UNIVERSIDADE FEDERAL DE MINAS GERAIS - UFMG, Belo Horizonte (BR)

(72) Inventors: Débora Guimarães Da Silva, Belo Horizonte (BR); Priscila Cristh Fonseca Alves, Belo Horizonte (BR); Lenardo Dos Santos Pereira, Rio de Janeiro (BR); Jailton Ferreira Do Nascimento, Rio de Janeiro (BR); Wander Luiz Vasconcelos, Nova Lima (BR); Daniela Cordeiro Leite Vasconcelos, Nova Lima (BR); Darley Carrijo De Melo, Rio de Janeiro (BR)

(21) Appl. No.: 19/239,422

(22) Filed: Jun. 16, 2025

(30) Foreign Application Priority Data
Jun. 24, 2024 (BR) BR 1020240129482

(51) Int. Cl. B01D 71/02; B01D 53/02; B01D 69/10; B01D 69/12

(52) U.S. Cl. CPC B01D 71/027; B01D 53/02; B01D 69/108; B01D 69/1216; B01D 71/025; B01D 2253/104; B01D 2253/106; B01D 2256/245; B01D 2257/504

(57) ABSTRACT

The present invention relates to a multilayer sol-gel green ceramic membrane for separating gaseous CO₂ from the natural gas. Since it is composed solely of ceramic materials (silica and alumina), the developed ceramic membrane has as its main characteristics high chemical, physical and mechanical stabilities. These characteristics guarantee its applicability in the process of separating CO₂ from the natural gas, even in streams with high concentrations of CO₂ and under high pressures, and the developed membrane also allows the execution of backwash operations, when necessary. This results in significant energy savings, reduction of the greenhouse gas emissions and a decrease in the carbon footprint of the natural gas production chain.

### FIELD OF THE INVENTION

The present invention is part of the Oil and Gas field, more precisely in the fields of oil production processes and primary processing technologies, and refers to a multilayer sol-gel green ceramic membrane for removal (gas separation) of CO₂ from the natural gas.

### BACKGROUNDS OF THE INVENTION

The removal of CO₂ from the natural gas is an extremely important operation in the oil and gas industry, since CO₂ represents the main contaminant in the natural gas, varying in concentrations of 5-70%, depending on the geographic location (Han Y, Ho W S W. Polymeric membranes for CO₂ separation and capture. J Memb Sci 2021; 628:1-24). In Brazil, ANP Ordinance No. 16 of 2008 establishes that, in order to be commercialized in the national territory, the natural gas must have a CO₂ content of less than 3% in moles (ANP, 2008. AGÊNCIA NACIONAL DO PETRÓLEO, GÁS NATURAL E BIOCOMBUSTÍVEIS (NATIONAL AGENCY OF OIL, NATURAL GAS AND BIOFUELS). Brazil: ANP Resolution No. 16, of 6/17/2008; 2008). Removing CO₂ from natural gas is not only a requirement to meet regulatory standards but also improves the quality and energy efficiency of natural gas, reduces environmental impacts resulting from CO₂ emissions and protects the integrity of equipment in the oil and gas industry (ANP, 2020 AGÊNCIA NACIONAL DO PETRÓLEO, GAS NATURAL E BIOCOMBUSTÍVEIS (NATIONAL AGENCY OF OIL, NATURAL GAS AND BIOFUELS). Estudo sobre o aproveitamento do gás natural no pré-sal (Study on the use of natural gas in the pre-salt layer); 2020).

Previously, gaseous separation of CO₂ was performed in different ways in various industrial segments, the main ones being: chemical absorption in liquids (amines, ionic liquids, glycols, etc.), adsorption in solids (zeolites, metal oxides, activated carbon, etc.), separation by membranes (polymeric, zeolitic, hybrid and contacting ones) and cryocondensation (Ochedi F O, Yu J, Yu H, Liu Y, Hussain A. Carbon dioxide capture using liquid absorption methods: A review. Environ Chem Lett 2021; 19:77-109; Vega F, Baena-Moreno F M, Gallego L M, Portillo E, Navarrete B. Current status of CO₂ chemical absorption research applied to CCS: Towards full deployment at industrial scale. Appl Energy 2020; 260:114313; Madejski P, Chmiel K, Subramanian N, Kus T. Methods and techniques for CO₂ capture: Review of potential. Energies 2022; 15:887; Kammerer S, Borho I, Jung J, Schmidt M S. Review: CO₂ capturing methods of the last two decades. Int J Environ Sci Technol 2023; 20:8087-104; Lian S, Song C, Liu Q, Duan E, Ren H, Kitamura Y. Recent advances in ionic liquids-based hybrid processes for CO₂ capture and utilization. J Environ Sci (China) 2021; 99:281-95; Sanders D F, Smith Z P, Guo R, Robeson L M, McGrath J E, Paul D R, et al. Energy-efficient polymeric gas separation membranes for a sustainable future: A review. Polymer (Guildf) 2013; 54:4729-61). Each of the aforementioned techniques has its disadvantages and limitations, such as high energy consumption, operation and maintenance costs, chemical or mechanical limitations, difficult scalability, need for complex regeneration or generation of non-recyclable/reusable waste (Ochedi F O, Yu J, Yu H, Liu Y, Hussain A. Carbon dioxide capture using liquid absorption methods: A review. Environ Chem Lett 2021; 19:77-109; Vega F, Baena-Moreno F M, Gallego L M, Portillo E, Navarrete B. Current status of CO₂ chemical absorption research applied to CCS: Towards full deployment at industrial scale. Appl Energy 2020; 260:114313; Lian S, Song C, Liu Q, Duan E, Ren H, Kitamura Y. Recent advances in ionic liquids-based hybrid processes for CO₂ capture and utilization. J Environ Sci (China) 2021; 99:281-95).

Currently, the CO₂ removal from the natural gas in the oil and gas industry is achieved by using dense polymeric membranes such as cellulose acetate, polyimides (PI), polyamides, polysulfone (PSF), polycarbonate (PC), and polyetherimide (PEI) (Han Y, Ho W S W. Polymeric membranes for CO₂ separation and capture. J Memb Sci 2021; 628:1-24; Cheng Y, Wang Z, Zhao D. Mixed matrix membranes for natural gas upgrading: Current status and opportunities. Ind Eng Chem Res 2018; 57:4139-69; Valappil R S K, Ghasem N, Al-Marzouqi M. Current and future trends in polymer membrane-based gas separation technology: A comprehensive review. J Ind Eng Chem 2021; 98:103-29). However, the natural gas processing plants face serious difficulties when using polymeric membranes, including plasticization effects, fouling, physical aging, long-term stability, short service life, high demand for platform space (70%), high energy consumption, and generation of high volume of non-recyclable or reusable waste (Han Y, Ho W S W. Polymeric membranes for CO₂ separation and capture. J Memb Sci 2021; 628:1-24; Cheng Y, Wang Z, Zhao D. Mixed matrix membranes for natural gas upgrading: Current status and opportunities. Ind Eng Chem Res 2018; 57:4139-69; Valappil R S K, Ghasem N, Al-Marzouqi M. Current and future trends in polymer membrane-based gas separation technology: A comprehensive review. J Ind Eng Chem 2021; 98:103-29; Aker R W, Lokhandwala K. Natural gas processing with membranes: An overview. Ind Eng Chem Res 2008; 47:2109-21).

To extend the useful life of polymeric membranes, it is essential to carry out pretreatments of the natural gas, such as dehydration and desulfurization, before passing the same through the membranes, avoiding the condensation of acidic water caused by the Joule-Thomson effect (Han Y, Ho W S W. Polymeric membranes for CO₂ separation and capture. J Memb Sci 2021; 628:1-24; Baker R W, Lokhandwala K. Natural gas processing with membranes: An overview. Ind Eng Chem Res 2008; 47:2109-21). In addition, the polymeric membranes undergo plasticization in the presence of high CO₂ concentrations and high pressures, leading to decreased selectivity (Han Y, Ho W S W. Polymeric membranes for CO₂ separation and capture. J Memb Sci 2021; 628:1-24; Cheng Y, Wang Z, Zhao D. Mixed matrix membranes for natural gas upgrading: Current status and opportunities. Ind Eng Chem Res 2018; 57:4139-69; Valappil R S K, Ghasem N, Al-Marzouqi M. Current and future trends in polymer membrane-based gas separation technology: A comprehensive review. J Ind Eng Chem 2021; 98:103-29). According to the literature, polymeric membranes for CO₂ separation tend to undergo plasticization at pressures in the range of 10 to 35 bar (1 to 3.5 MPa) and CO₂ concentrations ranging from 30 to 45 cm³(NTP)/cm³ (Valappil R S K, Ghasem N, Al-Marzouqi M. Current and future trends in polymer membrane-based gas separation technology: A comprehensive review. J Ind Eng Chem 2021; 98:103-29). The presence of contaminants, such as aromatic compounds and heavy hydrocarbons, can also result in plasticization, in addition to causing fouling (clogging) of the polymeric membranes (Valappil R S K, Ghasem N, Al-Marzouqi M. Current and future trends in polymer membrane-based gas separation technology: A comprehensive review. J Ind Eng Chem 2021; 98:103-29; Baker R W, Lokhandwala K. Natural gas processing with membranes: An overview. Ind Eng Chem Res 2008; 47:2109-21). Another challenge faced is the physical aging of the polymeric membranes. The polymers used in these membranes are in a non-equilibrium state and, over time, their polymer chains tend to relax, preferentially to a high-density, low-permeability form, reducing the flux of CO₂ through the membrane (Baker R W, Lokhandwala K. Natural gas processing with membranes: An overview. Ind Eng Chem Res 2008; 47:2109-21).

Physical aging, together with plasticization and fouling effects caused by the presence of contaminants, high CO₂ concentrations, and high feed pressures, limit the service life of the polymeric membranes to no more than 5 years (Chen X, Liu G, Jin W. Natural gas purification by asymmetric membranes: An overview. Green Energy Environ 2021; 6:176-92; Kadirkhan F, Goh P S, Ismail A F, Wan Mustapa W N F, Halim M H M, Soh W K, et al. Recent advances of polymeric membranes in tackling plasticization and aging for practical industrial CO₂/CH₄ applications—A review. Membranes (Basel) 2022; 12:1-58). Often, after only 3 years of operation, the polymeric membranes already show a reduction in CO₂/CH₄ separation performance of 20 to 30% (Kadirkhan F, Goh P S, Ismail A F, Wan Mustapa W N F, Halim M H M, Soh W K, et al. Recent advances of polymeric membranes in tackling plasticization and aging for practical industrial CO₂/CH₄ applications—A review. Membranes (Basel) 2022; 12:1-58), which often results in the need to replace the polymeric membrane modules every 3 years or less. Frequent replacements of the polymeric membranes cause serious environmental impacts, such as generation of non-recyclable/reusable waste, environmental contamination, high consumption of natural resources and a larger carbon footprint (Yadav P, Ismail N, Essalhi M, Tysklind M, Athanassiadis D, Tavajohi N. Assessment of the environmental impact of polymeric membrane production. J Memb Sci 2021; 622:118987), in addition to also resulting in high costs with shutdown in the production process, purchase of new modules and hiring of labor for replacements.

In addition to the difficulties related to plasticization, fouling, physical aging, long-term stability and short service life, another impact on the use of polymeric membranes for the removal of CO₂ from the natural gas in the oil and gas industry is the high energy consumption throughout the entire process, due to the need for more efficient pre-treatment of the natural gas and reinjection, at high pressures, of the CO₂-rich stream into the well for secondary recovery of oil and gas.

In Petrobras' current offshore gas processing, the natural gas, already separated from the oil, enters the gas treatment plant at a pressure of approximately 15 bar (1.5 MPa). It then goes through a compression step, where it is raised to approximately 55 bar (5.5 MPa), and is then subjected to pre-treatment with desulfurization (in fields that have H₂S in the reservoir), dehydration, removal of aromatic compounds and heavy hydrocarbons, in a dew point control unit, before finally being sent to the polymer membrane unit for CO₂ removal. The CO₂-rich stream (permeate) leaves the polymer membrane unit at a pressure significantly lower than the feed pressure, with pressure values of permeate ranging from 2 to 5 bar (200 to 500 kPa), depending on the type of polymer membrane used. The permeate stream then needs to be compressed to reach high pressures, typically around 500 bar (50 MPa), before being reinjected into the reservoir for secondary oil and gas recovery. This compression process for reinjection requires a substantial amount of energy, further increasing operating costs and contributing to the increase in the carbon footprint of the natural gas production process, since the energy used in the compressors comes from gas turbines on the platforms. Undoubtedly, the current operation with polymeric membranes in natural gas processing units is critical, with high demand for platform space (70%), high consumption of energy and inputs, in addition to the generation of a high volume of non-recyclable or reusable waste.

All these difficulties pointed out in the use of polymeric membranes make this technology practically unfeasible to be adopted in new platforms, especially considering the current prediction of a 244% increase in the total natural gas production in Brazil by 2032 (323 NMm³/day) (EPE, 2022. EMPRESA DE PESQUISA ENERGÉTICA. Estudos do Plano Decenal de Expansão de Energia 2032 —Previsão da Produção de Petróleo e Gás Natural (Studies of the Ten-Year Energy Expansion Plan 2032 —Oil and Natural Gas Production Prediction); 2022), compared to the production of 2022 (138 NMm³/day) (ANP, 2022. AGÊNCIA NACIONAL DO PETRÓLEO, GAS NATURAL E BIOCOMBUSTÍVEIS (NATIONAL AGENCY OF OIL, NATURAL GAS AND BIOFUELS). Encarte de Consolidagso da Produção 2022 —Boletim da Produgção de Petróleo e Gás Natural (Production Consolidation Insert 2022 —Oil and Natural Gas Production Bulletin); 2022). It is estimated that by 2032a significant portion, corresponding to 78% of the total natural gas production (252 Mm³/day), will come from the pre-salt (EPE, 2022. EMPRESA DE PESQUISA ENERGÉTICA. Estudos do Plano Decenal de Expansão de Energia 2032 —Previsão da Produgção de Petróleo e Gás Natural (Studies of the Ten-Year Energy Expansion Plan 2032 —Prediction of Oil and Natural Gas Production); 2022), where the CO₂ concentration can reach up to 25% (ANP, 2020 AGÊNCIA NACIONAL DO PETRÓLEO, GÁS NATURAL E BIOCOMBUSTÍVEIS (NATIONAL AGENCY OF OIL, NATURAL GAS AND BIOFUELS). Estudo sobre o aproveitamento do gás natural no pré-sal (Study on the use of natural gas in the pre-salt); 2020). The treatment and reinjection of such a substantial volume of gas using polymeric membranes would result in processing and compression units of unfeasible proportions on the platforms and with extremely high energy consumption. To meet this energy demand, it would be necessary to increase the electricity production capacity on the platforms to more than 100 MW, making it mandatory to monitor and control atmospheric emissions established by CONAMA Resolution No. 382 of 2006 (BRAZIL. CONAMA Resolution No. 372 of Dec. 26, 2006. Estabelece os limites máximos de emissão de poluentes atmosféricos para fontes fixas (Establishes maximum limits for the emission of atmospheric pollutants from stationary sources); 2006). This, in turn, would result in the need to install pollutant control equipment, such as desulfurizers, low-emission nitrogen oxide (NOx) burners and denitrifiers, which would further increase the natural gas production costs and require additional space on the platform.

In summary, the high demand for space on platforms, the significant energy consumption and the high costs related to equipment, labor and inputs, together with the environmental impacts resulting from the generation of large volumes of non-recyclable waste, make the use of polymeric membranes for the removal of CO₂ from the natural gas unsustainable in the medium and long term.

### STATE OF THE ART

The document on behalf of DAGANG, titled CARBON DIOXIDE REMOVAL FROM NATURAL GAS BY USING SILICA MEMBRANE refers to the removal of carbon dioxide from natural gas using a silica membrane with high performance and high selectivity of carbon dioxide/methane (CO₂/CH₄) and also to study the effect of pressure, inlet flow rate and duration of immersion coating on the separation performance. The ceramic membrane described in the document is composed solely of an alumina ceramic support and a selective silica layer. In turn, the ceramic membrane described in the present invention is composed of an alumina ceramic support and four ceramic layers that have different chemical compositions, porosity and pore structure. In addition, the membrane described in the aforementioned document does not have a porosity gradient between the support and the selective layer, since ceramic layers with intermediate porosities are not present in the aforementioned membrane. In contrast, the ceramic membrane proposed in the present invention was specially designed to create a porosity gradient between the ceramic support and the selective layer of microporous silica. The porosity gradient between the ceramic support and the selective ceramic layer plays a crucial role in the performance and efficiency of the ceramic membranes of gas separation.

The document on behalf of KAJAMA et al., titled USE OF NANOPOROUS CERAMIC MEMBRANES FOR CARBON DIOXIDE SEPARATION, refers to the use of nanoporous ceramic membranes for the separation of carbon dioxide in natural gas. In addition, it states that the sol-gel method is widely applied as the preferred preparation method for inorganic membranes. This method is being used to obtain microporous ceramic membranes, for example, by depositing silica layers on ceramic supports. Although both the aforementioned document and the present invention refer to a ceramic membrane for gas separation of carbon dioxide whose selective layer presents a nanoporous structure, the aforementioned document makes seven depositions of a single silica precursor solution (same chemical composition) on a tubular ceramic support of Al₂O₃ and TiO₂. From a chemical and morphological point of view, the seven depositions give rise to a single layer that presents a homogeneous structure throughout its entire thickness. Accordingly, the membrane produced in the document actually presents only a single layer of SiO₂ deposited on the Al₂O₃/TiO₂ ceramic support. In contrast, the present invention relates to a multilayer membrane where each of the 4 layers deposited on the ceramic support (av-Al₂O₃ and average pore size of 0.7-0.9 μm) have unique characteristics of chemical composition and/or porosity and pore size differentiating the same from the other layers. However, the membrane described in said document does not have a porosity gradient between the support and the selective layer, since ceramic layers with intermediate porosities are not present in said membrane. In contrast, the ceramic membrane proposed in the present invention was specially designed to create a porosity gradient between the ceramic support and the selective layer of microporous silica.

The document on behalf of NWOGU et al., titled MULTILAYER SILICA CERAMIC MEMBRANE FOR FLUE GAS AND NATURAL GAS SEPARATIONS, relates to a multilayer silica ceramic membrane for separations of flue gases and natural gas. Three depositions of a single silica precursor solution (same chemical composition) are made on a tubular ceramic support of Al₂O₃ and TiO₂. From a chemical and morphological point of view, the three depositions give rise to a single layer that presents a homogeneous structure throughout its entire thickness. Accordingly, the membrane produced in the document actually presents only a single layer of SiO₂ deposited on the ceramic support of Al₂O₃/TiO₂ (average pore diameter 6000 nm). In contrast, the present invention relates to a multilayer membrane where each of the 4 layers deposited on the ceramic support (α-Al₂O₃ and average pore size of 0.7-0.9 μm) have unique characteristics of chemical composition and/or porosity and pore size differentiating the same from the other layers. Furthermore, the membrane described in the aforementioned document does not have a porosity gradient between the support and the selective layer, since ceramic layers with intermediate porosities are not present in the aforementioned membrane. In contrast, the ceramic membrane proposed in the present invention was specially designed to create a porosity gradient between the ceramic support and the selective layer of microporous silica.

The document on behalf of SHIMEKIT et al., titled CERAMIC MEMBRANES FOR THE SEPARATION OF CARBON DIOXIDE—A REVIEW, provides a review on ceramic membranes for the separation of carbon dioxide from natural gas. It is mentioned that the inorganic membranes prepared from microporous glasses, ceramic materials such as aluminum oxide (Al₂O₃), silicon nitride (Si₃N₄), silicon carbide (SiC), metal oxide or metal alloys have relatively high resistance to abrasion and chemical and thermal degradation, and are therefore more suitable for use in operations under severe conditions such as corrosive environments and high temperatures. Although the aforementioned document discusses the general use of silica membranes in different gas separation contexts, it is important to highlight that the mention of generic and widely used words in the literature such as sol-gel and silica does not necessarily imply that the materials developed using these themes are identical or that the production techniques are the same. In turn, the present invention focuses on a specific and detailed application of multilayer ceramic membranes, whereas the aforementioned document mainly discusses the general principles behind silica membranes for gas separation.

The document on behalf of YEO et al., titled CONVENTIONAL PROCESSES AND MEMBRANE TECHNOLOGY FOR CARBON DIOXIDE REMOVAL FROM NATURAL GAS: A REVIEW, provides a review of conventional processes and membrane technology for carbon dioxide removal from the natural gas. Among these processes, ceramic membranes are mentioned as one of the options. There is further mentioned that the materials commonly used for ceramic membranes include Al₂O₃, TiO₂, ZrO₂ and SiO₂, etc. The sol-gel process is the usual method used for the preparation of porous ceramic membranes. Generally, a ceramic membrane is composed of three layers, which include: a macroporous support layer (pore size in the range of hundreds of nanometers), a mesoporous intermediate layer (pore size <10 nm), and a microporous top layer (pore size <1 nm). Out of all the three layers, only the top layer controls the type of gas species that permeates the membrane, while the other two layers provide mechanical strength to the ceramic membrane. Although the aforementioned document extensively discusses the use of inorganic membranes such as silica, alumina, and zirconia for various gas separation applications, it is important to note that the present invention offers a unique and differentiated contribution to this field. While the document provides an overview of the current state of inorganic membrane technology, the present invention presents a specific and detailed application of multilayer ceramic membranes for the selective separation of CO₂ in natural gas. One of the key points that differentiates the present invention is the specific methodology used for the fabrication of the multilayer ceramic membranes. While the document mainly discusses general methods, such as the sol-gel process, the present invention employs a combination of different techniques and unique manufacturing conditions that are not addressed to in said document. This includes the application of different ceramic layers with controlled porosities to optimize the selectivity and efficiency of CO₂ separation.

The document on behalf of MALEK, titled REMOVAL CARBON DIOXIDE FROM NATURAL GAS STREAM BY USING CERAMIC MEMBRANE, refers to the removal of carbon dioxide from the natural gas flow using a ceramic membrane. In this sense, it proposes the preparation of α-alumina substrate and preparation of silica membrane by the sol-gel method. Thus, the document aims at preparing a porous silica layer on a porous alumina substrate using the sol-gel method; and studying the permeability of carbon dioxide and methane in synthetic silica membranes. From a chemical and morphological point of view, the ceramic membrane described in the document is composed solely of an alumina ceramic support and a silica selective layer. In contrast, the ceramic membrane described in the present invention is composed of an alumina ceramic support and four ceramic layers that have different chemical compositions, porosity and pore structure. In addition, the membrane described in the aforementioned document does not have a porosity gradient between the support and the selective layer, since ceramic layers with intermediate porosities are not present in the aforementioned membrane. In contrast, the ceramic membrane proposed in the present invention was specially designed to create a porosity gradient between the ceramic support and the microporous silica selective layer.

Document U.S. Pat. No. 5,871,646 refers to a process for preparing a porous amorphous silica-alumina refractory oxide, particularly for preparing porous amorphous silica-alumina oxides of controlled pore size via the sol-gel route. These products are intended for use as separation membranes, particularly for separating polar fluids, such as carbon dioxide or water, from less polar fluids, such as methane. Specifically, said document describes a ceramic membrane with a selective layer of refractory oxide composed of alumina and silica, which in order to present a microporous structure must be composed of at least 80% by mass of silica. In contrast, the present invention reports the use of a microporous selective layer based on silicon oxide (silica) using as reagents a silicon alkoxide, an alcohol compatible with the alkoxide used, water and an acid. Furthermore, the membrane described in the aforementioned document does not have a porosity gradient between the support and the selective layer, since ceramic layers with intermediate porosities are not present in the aforementioned membrane. In contrast, the ceramic membrane proposed in the present invention was specially designed to create a porosity gradient between the ceramic support and the selective layer of microporous silica.

Therefore, unlike the state of the art, the green ceramic membrane (GCM) proposed in the present invention brings together all the characteristics necessary to overcome the serious difficulties faced in the use of polymeric membranes in the separation of CO₂ from natural gas, such as plasticization, fouling, aging, long-term stability, short service life, high demand for platform space (70%), high energy consumption and generation of non-recyclable or reusable waste (Han Y, Ho W S W. Polymeric membranes for CO₂ separation and capture. J Memb Sci 2021; 628:1-24; Cheng Y, Wang Z, Zhao D. Mixed matrix membranes for natural gas upgrading: Current status and opportunities. Ind Eng Chem Res 2018; 57:4139-69; Valappil R S K, Ghasem N, Al-Marzouqi M. Current and future trends in polymer membrane-based gas separation technology: A comprehensive review. J Ind Eng Chem 2021; 98:103-29; Baker R W, Lokhandwala K. Natural gas processing with membranes: An overview. Ind Eng Chem Res 2008; 47:2109-21). The chemical bonds in ceramic materials (e.g., Al₂O₃ 1674 kJ/mol; SiO₂ 879 kJ/mol) are much stronger than in polymeric materials (10-50 kJ/mol) (Fischer T. Types of Materials, Electron Energy Bands, and Chemical Bonds. Mater. Sci. Eng. students, Academic Press; 2009, p. 3-33), and this is one of the most advantageous features of this green ceramic membrane. This is because this characteristic gives the same sufficient chemical resistance and mechanical strength to allow it to be used in extreme conditions, in which the polymeric membranes would not be able to operate, such as high concentrations of CO₂, high pressures, temperatures above 200° C. and acidic or alkaline environments.

The plasticization effect in polymeric membranes occurs when the concentration of gas inside the membrane increases to the point of promoting the relaxation (expansion) of the polymer chains, which, in turn, increases its diffusion coefficient, allowing other gases, such as methane, to also cross the membrane, reducing its CO₂/CH₄ selectivity. In the polymeric membranes, the plasticization is caused by high pressures and CO₂ concentrations, as well as by the presence of contaminants such as aromatic compounds and hydrocarbons (Valappil R S K, Ghasem N, Al-Marzouqi M. Current and future trends in polymer membrane-based gas separation technology: A comprehensive review. J Ind Eng Chem 2021; 98:103-29; Sanders D F, Smith Z P, Guo R, Robeson L M, McGrath J E, Paul D R, et al. Energy-efficient polymeric gas separation membranes for a sustainable future: A review. Polymer (Guildf) 2013; 54:4729-61). Unlike the polymeric membranes, the green ceramic membrane proposed in the present invention is not subject to plasticization thanks to the physical and chemical properties of its structure. It is formed by a solid and rigid structure due to its strong chemical bonds, and has a network of pores that was designed to allow the selective passage of CO₂ and restrict the passage of CH₄ based on the sizes of the molecules of each gas (molecular sieve). This means that, even if the ceramic membrane of this invention is exposed to high pressures, high concentrations of CO₂ or contaminants, its pore structure, and consequently its selectivity, remain unchanged due to the presence of chemical bonds that are considerably stronger than those found in the polymeric membranes (Fischer T. Types of Materials, Electron Energy Bands, and Chemical Bonds. Mater. Sci. Eng. students, Academic Press; 2009, p. 3-33).

The presence of contaminants can not only result in the plasticization of the polymeric membranes, but can also lead to clogging (fouling), which represents a serious issue in terms of processing, since the structure of the polymeric material does not allow for backwashing operations (Valappil R S K, Ghasem N, Al-Marzouqi M. Current and future trends in polymer membrane-based gas separation technology: A comprehensive review. J Ind Eng Chem 2021; 98:103-29). On the other hand, the ceramic membrane of the present invention has a robust and porous structure, enabling backwashing and preventing the accumulation of contaminants. This represents a significant advantage, since backwashing contributes to extending its useful life and maintaining its performance at optimal levels.

Since the main separation mechanism of the green ceramic membrane of the present invention is molecular sieving and presenting chemical resistance to both water and acidic media, it could be used not only for the effective removal of CO₂ (0.33 nm) from the natural gas (CH₄=0.38 nm), but also for the selective removal of moisture (H₂O=0.28 nm) and H₂S (0.36 nm), albeit with different degrees of selectivity for each gas. This suggests that pretreatment steps, such as dehydration and desulfurization, which were previously required with polymeric membranes (Han Y, Ho W S W. Polymeric membranes for CO₂ separation and capture. J Memb Sci 2021; 628:1-24; Baker R W, Lokhandwala K. Natural gas processing with membranes: An overview. Ind Eng Chem Res 2008; 47:2109-21), can now be dispensed with, since the ceramic membrane of this invention is capable of selectively removing from natural gas all molecules with a diameter smaller than methane. This has a direct impact on the space required on the platform for installation of the processing unit, suggesting that by adopting the green ceramic membrane described in this invention, the natural gas processing unit can be dimensioned more compactly compared to using polymeric membranes.

Due to the nature of its chemical bonds, the green ceramic membrane of the present invention is less prone to chemical degradation and physical aging over time, giving it much superior long-term stability than polymeric membranes. Long-term stability, combined with the ability to backwash in cases of contaminant accumulation, allows it to have a significantly longer service life than the polymeric membranes commonly used in the oil and gas industry. The expectation is that, when applied in the separation of CO₂ from the natural gas, the green ceramic membrane of this invention can achieve a service life of more than 20 years (Asif M B, Zhang Z. Ceramic membrane technology for water and wastewater treatment: A critical review of performance, full-scale applications, membrane fouling and prospects. Chem Eng J 2021; 418:1-18; Jarvis P, Carra I, Jafari M, Judd S J. Ceramic vs polymeric membrane implementation for potable water treatment. Water Res 2022; 215:1-9), which is 4 to 6 times longer than the average service life of the polymeric membranes (Chen X, Liu G, Jin W. Natural gas purification by asymmetric membranes: An overview. Green Energy Environ 2021; 6:176-92; Kadirkhan F, Goh P S, Ismail A F, Wan Mustapa W N F, Halim M H M, Soh W K, et al. Recent advances of polymeric membranes in tackling plasticization and aging for practical industrial CO₂/CH₄ applications—A review. Membranes (Basel) 2022; 12:1-58).

A longer service life is directly related to the reduction in the frequency of operational shutdowns to change the filter elements, which in turn results in greater productivity, cost reduction and a significant reduction in waste generation. Inevitably, the time will come when the ceramic membrane module will need to be replaced with a new one, which will result in the generation of waste. However, it is important to emphasize that these wastes from the green ceramic membrane of the present invention are fully reusable in other industrial sectors, eliminating the need to dispose of them in landfills and contributing to a more sustainable approach. Among the sectors that can take advantage of their waste, the following stand out: the ceramic industry, where these wastes can be used as raw material in the manufacture of bricks and tiles; civil construction, where they can be incorporated into mortars and concrete; road construction, where they can be used as aggregates in paving; and in the cement industry, where waste similar to that of ceramic membranes has proven efficient when used as a filler in Portland cement (Inocente J M, Elyseu F, Jaramillo Nieves L J, Cargnin M, Peterson M. Evaluation of the use of silica—alumina refractory waste as a supplementary cementitious material. Ceramica 2021; 67:203-9).

Another significant advantage of the green ceramic membrane of the present invention, compared to the polymeric membranes, is that its porous structure allows the passage of CO₂ with a minimum pressure loss, enabling its operation with pressure differences (ΔP) between the feed and the permeate as low as 1 bar (100 MPa). In the context of industrial natural gas processing, this implies that the permeate stream will exit the ceramic membrane module at higher pressures than those observed in the polymeric membranes. As a result, the compression and reinjection of the permeate stream into the well can be performed with smaller compressors compared to those used in systems with polymeric membranes. This, in turn, will reduce the space required on the platform, the energy consumption, the operating costs and the carbon footprint associated with the process. It is important to highlight that the main driving force in the green ceramic membrane of this invention is the pressure difference (ΔP) between the feed and the permeate; the greater this difference, the greater the gas flux through the membrane, and the opposite is also true. Therefore, when considering efficiency in natural gas processing, it is crucial to find a balance between the gas flux through the membranes and the permeate pressure.

### SUMMARY OF THE INVENTION

The present invention aims at proposing a green ceramic membrane (GCM) for separating gaseous CO₂ from the natural gas. As it is composed solely of ceramic materials (silica and alumina), the main characteristics of the developed ceramic membrane are high chemical, physical and mechanical stabilities. These characteristics guarantee its applicability in the process of separating CO₂ from the natural gas, even in streams with high CO₂ concentrations and under high pressures, and the developed membrane also allows for backwash operations to be performed, when necessary. In addition, the gas separation principle of the green ceramic membranes (molecular sieve) allows the same to operate at higher pressures in the permeate stream (CO₂-rich stream), enabling the use of smaller compressors to recompress the gas before reinjection into the oil wells. This results in significant energy savings, reduced greenhouse gas emissions and a reduction in the carbon footprint of the natural gas production chain.

### BRIEF DESCRIPTION OF THE INVENTION

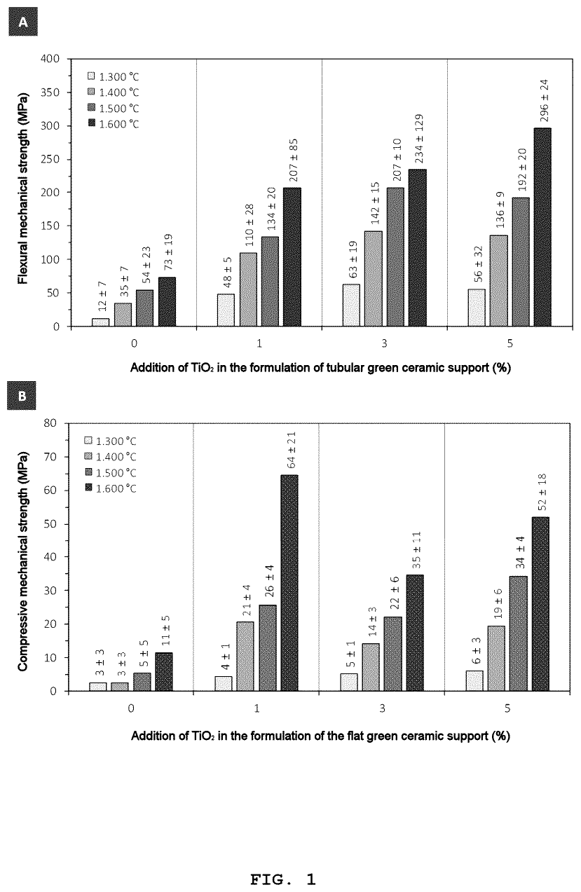

FIG. 1 shows the mechanical strength of the green ceramic membranes with ceramic supports of different chemical compositions and shaped via (A) extrusion for tubular ceramic supports and (B) pressing for flat ceramic supports and subjected to different sintering temperatures.

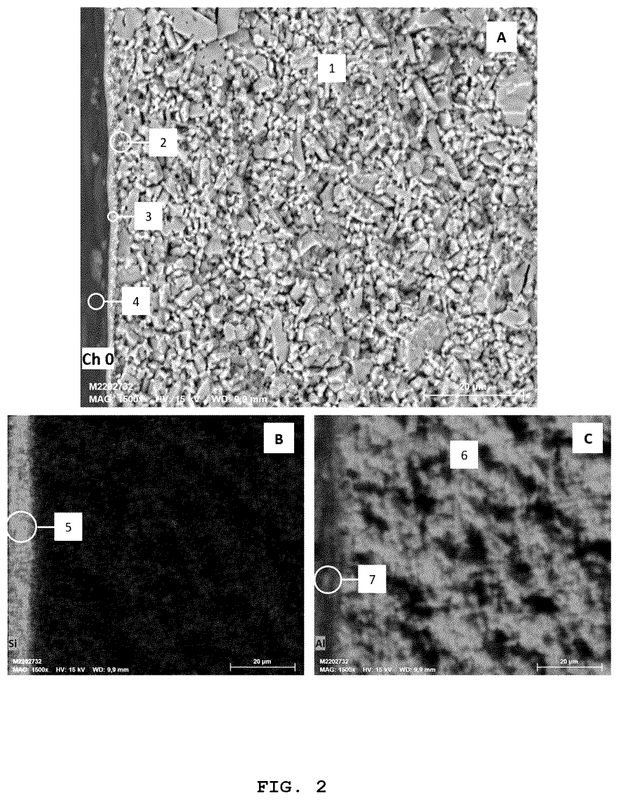

FIG. 2 shows in (A) the scanning electron photomicrograph of the cross section of the ceramic membrane for gas separation, composition maps of the chemical elements (B) silicon and (C) aluminum.

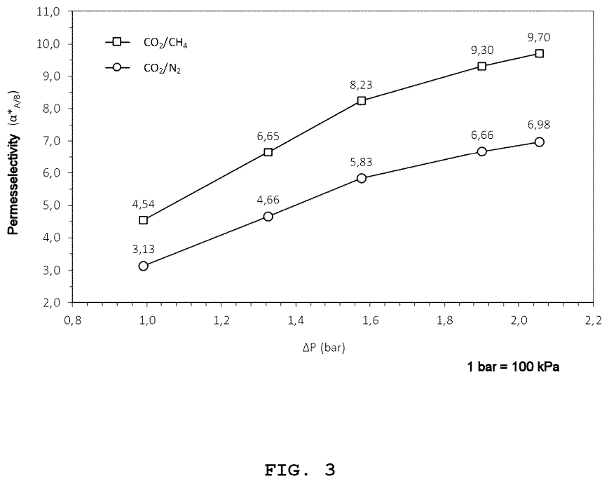

FIG. 3 shows the gas permesselectivity of the green ceramic membrane for the gas pairs CO₂/CH₄ and CO₂/N₂ at different values of ΔP and feed pressures of 2, 4, 6, 8, and 9 bar (200, 400, 600, 800, and 900 MPa).

### DETAILED DESCRIPTION OF THE INVENTION

The present invention relates to a multilayer sol-gel green ceramic membrane for removal (gaseous separation) of CO₂ from the natural gas (CO₂/N₂ or CO₂/CH₄) comprising the following components:
(1) Ceramic support of micrometric particles of α-Al₂O₃;
(2) First intermediate layer of submicrometric particles of α-Al₂O₃;
(3) Second intermediate layer of nanometric particles of γ-Al₂O₃;
(4) Separation sublayer of mesoporous silica; and
(5) Final separation layer of microporous silica.

The ceramic support composed of aluminum oxide in the alpha crystalline phase, methyl cellulose 27.5—31.5%, deionized water and glycerol, is the base structure responsible for providing mechanical strength to the ceramic membrane assembly, so that it can withstand the pressure of the gas stream during the separation process. It has an average pore size of 0.7-0.9 μm.

The first intermediate layer of submicrometric particles of α-Al₂O₃ is composed of aluminum oxide in the alpha crystalline phase, deionized water, polyvinyl alcohol PVA 35%, carboxymethyl cellulose CMC 90% and carboxylic acid 65%. It has an average pore size of 80-100 nm.

The second intermediate layer of nanometric particles of γ-Al₂O₃ is composed of aluminum tri-sec-butoxide 97%, nitric acid, deionized water and polyvinyl alcohol PVA 35%. It has an average pore size of 4-20 nm.

The separation sublayer of mesoporous silica is composed of tetraethyl orthosilicate, hydrochloric acid, anhydrous ethanol, deionized water and triethylhexylammonium bromide. It has an average pore size of 2 nm.

Both the intermediate layers and the sublayer of mesoporous silica are responsible for providing a porosity gradient between the ceramic support.

In turn, the final separation layer of microporous silica is composed of tetraethyl orthosilicate, hydrochloric acid, anhydrous ethanol and deionized water. It has an average pore size of less than 0.4 nm.

This porosity gradient is essential to allow the green ceramic membrane to present high CO₂ gas permeance values, in the order of 1.10×10⁻⁶ mol/m²·s·Pa. The variation in the porosity of the intermediate and separation layers allows for improved selectivity in CO₂ retention, ensuring the efficiency of the separation process.

The first intermediate layer of α-Al₂O₃ of the green ceramic membrane is obtained by preparing and depositing a suspension of submicrometric particles on the surface of the ceramic support, followed by heat treatment for sintering and consolidation of the layer. The starting material of the first intermediate layer is specially selected based on the pore size of the ceramic support, so that the average size of the α-Al₂O₃ particles is equal to or greater than the average pore size of the ceramic support, preventing the penetration of the first intermediate layer of α-Al₂O₃ into the pores of the ceramic support.

The second intermediate layer of γ-Al₂O₃ of the green ceramic membrane is obtained by preparing and depositing a solution of nanometric γ-AlOOH particles, prepared via the sol-gel method, on the surface of the α-Al₂O₃ layer followed by heat treatment to consolidate the layer and crystallize the γ-AlOOH into γ-Al₂O₃. More than one γ-Al₂O₃ coating can be used to ensure that a uniform coating across the entire surface of the first intermediate layer of α-Al₂O₃ is obtained. The sol-gel synthesis of nanometric particles of γ-AlOOH is prepared according to the pore size of the first intermediate layer of α-Al₂O₃, in order that the process parameters are carefully controlled so that the γ-AlOOH particles have an average size equal to or greater than the pore size of the first intermediate layer, avoiding the penetration of the second intermediate layer of γ-AlOOH into the α-Al₂O₃ layer.

The separation sublayer of mesoporous silica is obtained by preparing and depositing on the second intermediate layer of γ-AlOOH a solution of silica polymer chains, prepared via the sol-gel method, with the presence of at least one pore-forming agent, which after appropriate heat treatment presents itself as a solid three-dimensional network of mesoporous silica. More than one coating of mesoporous silica can be used to ensure that a uniform coating along the entire surface of the first intermediate layer of γ-Al₂O₃ is obtained. The sol-gel synthesis of the silica polymer chain solution with pore-forming agent is prepared according to the pore size of the second intermediate layer of γ-Al₂O₃, in order that the process parameters are carefully controlled so that nanoparticles of silica polymer chains have an average size equal to or greater than the pore size of the second intermediate layer, avoiding the penetration of the separation sublayer into the γ-AlOOH layer.

The final separation layer of microporous silica is obtained by preparing and deposition on the separation sublayer of mesoporous silica of a solution of silica polymer chains, prepared via the sol-gel method, which after appropriate heat treatment presents itself as a solid three-dimensional network of microporous silica with an average pore size of the order of the diameter of the CO₂ molecule. More than one microporous silica coating can be used to ensure that a uniform coating is obtained across the entire surface of the separation sublayer of mesoporous silica. The sol-gel synthesis of the silica polymer chain solution is prepared according to the pore size of the separation sublayer of mesoporous silica, in order that the process parameters are carefully controlled so that the silica polymer chain nanoparticles have an average size equal to or greater than the pore size of the separation sublayer of mesoporous silica, preventing the penetration of the final separation layer of microporous silica into the separation sublayer.

As it is composed solely of ceramic materials (silica and alumina), the developed ceramic membrane has high chemical, physical and mechanical stabilities as its main characteristics. These characteristics guarantee its applicability in the process of separating CO₂ from the natural gas, even in streams with high CO₂ concentrations and under high pressures, and the developed membrane also allows for backwash operations to be carried out, when necessary. In addition, the gas separation principle of the green ceramic membranes (molecular sieve) allows the same to operate at higher pressures in the permeate stream (CO₂-rich stream), enabling the use of smaller compressors to recompress the gas before the reinjection into oil wells. This results in significant energy savings, reduced greenhouse gas emissions and a reduction in the carbon footprint of the natural gas production chain.

### Examples of the Invention

FIG. 1 shows the results of the mechanical strength of the green ceramic membranes that were produced from ceramic supports of different chemical compositions and shaped via extrusion for the tubular ceramic supports (A) and pressing for the flat ceramic supports (B) and subjected to different sintering temperatures. It is important to emphasize that the mechanical strength of the green ceramic membranes is directly related to the mechanical strength of the used ceramic supports, since the ceramic supports constitute the base structure that provides mechanical strength to the ceramic membrane assembly. As shown in FIG. 1, green ceramic membranes with mechanical strengths of 3 to 296 MPa were produced by varying the method of forming the ceramic supports, chemical composition and sintering temperature. According to graph (A) in FIG. 1, and considering that 1 MPa is approximately equivalent to 10 bar, the green ceramic membranes with tubular ceramic supports, obtained via extrusion, demonstrated sufficient mechanical strength to withstand pressures of 120 to 2960 bar (12 to 296 MPa), according to the processing conditions of the ceramic support. Regarding the flat green ceramic membranes (graph B in FIG. 1), these presented sufficient mechanical strength to withstand pressures between 30 and 640 bar (3 and 64 MPa).

The geometry of the green ceramic membrane should be selected based on the desired operating mode for the membrane. The tubular geometry, for example, is suitable for the application of the ceramic membranes in cross-flow mode, while the flat geometry is suitable, for example, for applications in dead-end mode. The determination of the processing parameters of the ceramic support (chemical composition and sintering temperature) is intrinsically linked to the operating conditions to which the green ceramic membrane will be subjected, and it is necessary to adjust the same according to the specific application of the green ceramic membrane.

The possibility of working with ceramic membranes of gas separation with a wide range of mechanical strengths is of great importance from an economic and environmental point of view. This is due to the fact that, depending on the final application of the membrane, the heat treatment temperature of the ceramic support can be adjusted to achieve a desired mechanical strength. For example, a ceramic membrane for gaseous separation of CO₂ from the natural gas under topside conditions, where pressures typically range around 60 bar (6 MPa), can be successfully produced by using a ceramic support heat-treated at 1300° C. Compared to a membrane whose ceramic support has been heat-treated at 1600° C., the membrane with a support at 1300° C. has a considerably lower energy consumption, resulting in a reduced carbon footprint and lower production costs.

FIG. 2 shows a scanning electron microscopy (SEM) image of the cross-section of the green ceramic membrane with the composition maps of the chemical elements aluminum and silicon. In image (A), the structures corresponding to the following elements are identified: ceramic support of Al₂O₃ (1), intermediate layers of Al₂O₃ (2), sublayer and separation layer of SiO₂ (3), and the separation surface of SiO₂ of the green ceramic membrane (4).

Image (B) of FIG. 2 presents the chemical composition map of the element silicon obtained via energy dispersive spectroscopy (EDS) of the image in (A) of FIG. 2. It is observed that the region with a high concentration of the element silicon in region (5) is in agreement with the regions where the sublayer and separation layer of SiO₂ (3) are located, as well as the separation surface of SiO₂ of the green ceramic membrane (4). This confirms the existence of the selective layer of silica (SiO₂) on the separation surface of the green ceramic membrane.

Image (C) of FIG. 2 shows the chemical composition map of the element aluminum, obtained via energy dispersive spectroscopy (EDS) of the image in (A) of FIG. 2. It is possible to note that the region with a high concentration of the element aluminum (6) is compatible with the regions corresponding to the ceramic support of Al₂O₃ (1) and the intermediate layers of Al₂O₃ (2), confirming the existence of a support and intermediate layers of alumina (Al₂O₃). Additionally, image (C) of FIG. 2 allows to verify the presence of the element aluminum in the region where the silica coating is located (7). The presence of the element aluminum in this region is justified by the penetration depth of the electron beam (typically greater than 1 μm) on the surface of the material. This is because the penetration depth goes beyond the thickness of the silica coatings (typically between 400 and 700 nm) of the green ceramic membrane, and therefore, in this region, the existence of aluminum in the lower layers (intermediate layers of Al₂O₃ and ceramic support of Al₂O₃) is detected.

FIG. 3 presents examples of data related to the permesselectivity of the green ceramic membrane for the gas pairs CO₂/CH₄ and CO₂/N₂, at feed pressures of 2, 4, 6, 8, and 9 bar (200, 400, 600, 800, and 900 MPa). The tests were carried out at room temperature (≈25° C.) using a gas permeation system and a permeation cell. The results indicate that a ΔP of 1 bar (100 kPa) between the feed and the permeate is already configured as a sufficient driving force for the separation process to occur. The results demonstrate the remarkable ability of the green ceramic membrane to selectively separate CO₂ molecules from molecules with larger molecular diameters, such as N₂ and CH₄ molecules. The separation efficiency is directly proportional to the relative size of the molecules compared to CO₂, indicating that the green ceramic membrane has a structure with controlled pore size. The predominant separation mechanism is that of a molecular sieve, which allows the selective passage of CO₂ molecules while retaining molecules with larger molecular diameters.

In this example, the most expressive permesselectivity values were obtained under a feed pressure of 9 bar (900 kPa) and a ΔP of 2.1 bar (210 kPa). Under these specific conditions, the CO₂/CH₄ permesselectivity reached 9.70, while the CO₂/N₂ permesselectivity was 6.98. Additionally, for a supply pressure of 9 bar (900 kPa) and a ΔP of 2.1 bar (210 kPa), the permeance values for CO₂, CH₄ and N₂ gases were 1.10×10⁻⁶ mol/m²·s·Pa, 1.12×10⁻⁷ mol/m²·s·Pa and 1.55×10-?mol/m²·s·Pa, respectively.

### Application of the Invention

The removal of carbon dioxide (CO₂) from gas streams is a necessity in various industries due to environmental, product quality and regulatory reasons. The green ceramic membrane (GCM) for CO₂ separation of the present invention can be used in the following areas without the need for adaptations:
1. Oil and gas industry: The green ceramic membrane can be efficiently used to remove gaseous CO₂ from the natural gas on the topside, contributing to high-quality gas production, operational efficiency, and compliance with environmental regulations.
2. CO₂ removal from exhaust gas: Separating carbon dioxide (CO₂) from exhaust gases is crucial for reducing carbon emissions and mitigating climate changes. The green ceramic membrane of this invention can be used to capture CO₂ from exhaust gas streams, allowing for its subterrain storage or use in industrial processes (He X, Chen D, Liang Z, Yang F. Insight and comparison of energy-efficient membrane processes for CO₂ capture from flue gases in power plant and energy-intensive industry. Carbon Capture Sci Technol 2022; 2:100020).
3. Direct air capture of CO₂: Direct air capture of carbon dioxide (CO₂), also known as DAC, is a technology designed to remove CO₂ from the Earth's atmosphere. This approach is considered an important part of the strategies to combat climate changes and mitigate rising levels of CO₂ in the atmosphere. The green ceramic membrane can be used to directly capture CO₂ from the air for later use in different industrial sectors or geological storage (Castel C, Bounaceur R, Favre E. Membrane processes for direct carbon dioxide capture from air: Possibilities and limitations. Front Chem Eng 2021; 3:1-15; Ozkan M, Nayak S P, Ruiz A D, Jiang W. Current status and pillars of direct air capture technologies. IScience 2022; 25:103990).
4. Biogas purification and biomethane production: The green ceramic membrane of this invention can be used to separate CO₂ from biogas, resulting in a higher quality gas with a reduced CO₂ content, classified as biomethane. This is essential because CO₂ is a major contaminant in biogas that can affect combustion efficiency and reduce the calorific value of the gas. In addition, the CO₂ removal is essential to meet regulatory and biomethane quality standards (Baena-Moreno F M, le Saché E, Pastor-Pérez L, Reina T R. Membrane-based technologies for biogas upgrading: A review. Environ Chem Lett 2020; 18:1649-58; Nithin Mithra S, Ahankari S S. Nanocellulose-based membranes for CO₂ separation from biogas through the facilitated transport mechanism: a review. Mater Today Sustain 2022; 19:100191; Khan M U, Lee J T E, Bashir M A, Dissanayake P D, Ok Y S, Tong Y W, et al. Current status of biogas upgrading for direct biomethane use: A review. Renew Sustain Energy Rev 2021; 149:111343).
5. Cement industry: During the cement manufacturing process, limestone is heated in a kiln to produce cement clinker, releasing CO₂ as a byproduct. The green ceramic membrane of this invention can be used to capture the CO₂ released during the limestone calcination and also exhaust gases. This capture can be performed directly in the cement manufacturing process, helping to reduce the CO₂ emissions (Guo Y, Luo L, Liu T, Hao L, Li Y, Liu P, et al. A review of low-carbon technologies and projects for the global cement industry. J Environ Sci (China) 2023; 136:682-97).
6. Food and beverage industry: Carbon dioxide is widely used in the food industry to extend the shelf life of the food products and maintain their quality. It also plays an essential role in the beverage industry, contributing to the taste, texture, and preservation of a variety of products, from soft drinks to beer and spirits. The green ceramic membrane can be used to obtain and purify CO₂ for food preservation and freezing or carbonation of carbonated beverages (Ozkan M, Nayak S P, Ruiz A D, Jiang W. Current status and pillars of direct air capture technologies. IScience 2022; 25:103990; Wang W, Rao L, Wu X, Wang Y, Zhao L, Liao X. Supercritical carbon dioxide applications in food processing. Food Eng Rev 2021; 13:570-91).
7. Agriculture: The use of carbon dioxide (CO₂) in greenhouses is a common agricultural practice that can significantly improve plant growth and yield. This technique is known as CO₂ enrichment and involves increasing the CO₂ concentration in the greenhouse atmosphere to levels above those found in the ambient atmosphere. The green ceramic membrane can be used in the selective separation of CO₂ to later be injected into greenhouses to improve crop growth, quality and yield (Thomson A, Price G W, Arnold P, Dixon M, Graham T. Review of the potential for recycling CO₂ from organic waste composting into plant production under controlled environment agriculture. J Clean Prod 2022; 333:130051).
8. CO₂ concentration in photosynthesis and aerobic fermentation: In anaerobic fermentation processes or in systems involving photosynthetic organisms such as algae, CO₂ can be a critical input for the growth and metabolism of microorganisms (Kajla S, Kumari R, Nagi G K. Microbial CO₂ fixation and biotechnology in reducing industrial CO₂ emissions. Arch Microbiol 2022; 204:1-20). The green ceramic membrane can be used to concentrate and deliver CO₂ directly to microorganisms, increasing the efficiency of the fermentation process.

The green ceramic membrane developed in the present invention was designed with a pore structure optimized for the separation of CO₂ from the natural gas in the topside, where the gas is in a gaseous state. However, this membrane has the potential to be applied in the separation of CO₂ from the natural gas in subsea environments, where the gases are in a supercritical state. To enable this expansion of use, it is necessary to adjust the pore structure of the membrane, making it suitable for the separation of fluids in a supercritical state. In addition, by means of adaptations, the green ceramic membrane is also effective in removing other contaminants from natural gas, such as H₂S and moisture, both in the topside and in the subsea environment. Another possible application of the green ceramic membrane in the oil and gas industry is in the production of hydrogen in the steam reforming of natural gas. In this process, the natural gas is reacted with water vapor in the presence of a catalyst to produce hydrogen and carbon monoxide (CO). The hydrogen produced needs to be separated from CO and then used in oil refining processes such as hydrogenation, hydrotreating, and hydrocracking (Lei L, Lindbrethen A, Hillestad M, He X. Carbon molecular sieve membranes for hydrogen purification from a steam methane reforming process. J Memb Sci 2021; 627:119241; Akbari A, Omidkhah M. Silica-zirconia membrane supported on modified alumina for hydrogen production in steam methane reforming unit. Int J Hydrogen Energy 2019; 44:16698-706). This potential versatility of the green ceramic membrane makes it a valuable tool for improving the quality of natural gas under various operating conditions, expanding its applications in different industrial scenarios.

In summary, the use of the green ceramic membrane described in the present invention represents a comprehensive solution to address to the main difficulties associated with the use of polymeric membranes. This green ceramic membrane stands out for not presenting plasticization, exhibiting superior chemical resistance and mechanical strength, having long-term stability, eliminating the need for dehydration and desulfurization steps, allowing backwashing to reduce fouling, having a longer service life, generating waste that is 100% reusable and causing a smaller environmental impact with a reduced carbon footprint. In addition, it can operate with permeate at high pressures, requiring smaller compressors for reinjection of the CO₂-rich stream into the well, which results in more compact natural gas treatment units with lower energy consumption.

### Advantages of the Invention

The use of the green ceramic membrane (GCM) of the present invention for the separation of CO₂ from natural gas (NG) offers several advantages, including economic advantages compared to the polymeric membranes (PM), advantages in terms of health and safety, both for workers in the oil and gas industry and for the environment, advantages in terms of reliability compared to the polymeric membranes (PM) traditionally used, significant environmental advantages compared to the conventional technologies, such as polymeric membranes, and social advantages, the main ones being:

### Economic Advantages/Productivity

Reduction of operating costs: The GCM has a significantly longer useful life (>20 years) than PMs (3-5 years). A longer useful life is directly linked to a reduction in the number of operational shutdowns for changing the filter elements, ensuring lower maintenance costs.
Energy savings: Due to the GCM's ability to operate at higher pressures in the permeate stream, smaller compressors are required to reinject the CO₂-rich stream into the well. This reduces the energy consumption, which is economically advantageous.
Compact NG processing unit: The reduced need for large compressors allows the NG processing unit to be dimensioned more compactly. This saves space on the platform, which may be critical, and reduces costs associated with infrastructure.
Waste reduction: GCM waste can be fully reused in other industrial sectors, which eliminates the need to dispose of the same in landfills. This is not only environmentally beneficial, but can also represent a source of revenue through the sale of this waste to other industries.
Lower maintenance costs: The chemical resistance and the mechanical strength of GCM reduce the need for frequent maintenance due to damage or chemical degradation. This results in fewer process interruptions and lower costs associated with maintenance.
Increased productivity: Due to greater stability and reduced maintenance requirements, the ceramic membrane can operate continuously for long periods, increasing the overall productivity of the NG processing unit.
Reduction of greenhouse gas emissions: The energy savings and reduction in carbon footprint associated with the use of GCM contribute to the reduction of the greenhouse gas emissions, which can be advantageous in terms of compliance with environmental regulations and green marketing.
Possibility of reducing pretreatment steps: GCM is capable of selectively removing moisture and H₂S from NG, eliminating the need for additional pretreatment steps. This reduces costs and operational complexity.
Sustainability: The GCM's backwash capability, together with the recyclability of its waste, contributes to a more sustainable approach, which is valued by investors and regulators.

In summary, the use of the green ceramic membrane (GCM) of this invention not only improves the efficiency of the CO₂ separation process from the natural gas, but also offers several economic advantages, including reduced operating costs, energy savings, reduced space requirements, reduced waste and increased productivity, making it an economically attractive option for the oil and gas industry.

### Health/Safety Advantages

Lower risk of flammability: Unlike polymeric membranes, the materials that make up GCM are non-flammable, reducing the risk of fire or explosion and contributing to the safety of the facilities and workers.
Chemical and mechanical stability: The chemical and mechanical stability of GCM contributes to its durability and resistance in challenging industrial environments, such as acidic or alkaline environments. This reduces the risk of leaks or failures that could pose threats to the health and safety of the workers.
Reduced need for maintenance: The mechanical strength and the chemical resistance of the GCM reduce the need for frequent maintenance, reducing the exposure of the workers to potentially hazardous environments and saving on maintenance costs.
Reduction of greenhouse gas emissions: The energy savings associated with the use of the GCM contribute to the reduction of greenhouse gas emissions, which is beneficial to public health in terms of air quality and combating climate changes.
Bioinert materials: The materials that may be present in the final GCM composition, such as alumina and silica, are non-toxic and bioinert materials that do not pose risks to human health or the environment. Such materials are commonly used in dentistry and orthopedics in the form of implants, coatings, sensors and medical devices, in addition to many other applications related to the health sector (Punj S, Singh J, Singh K. Ceramic biomaterials: Properties, state of the art and future prospectives. Ceram Int 2021; 47:28059-74).
Non-hazardous and reusable waste: The GCM waste is fully reusable in other industrial sectors, eliminating the need to dispose of it as hazardous waste. This reduces the risk of environmental contamination and the health risks associated with the handling of hazardous waste.
Lower environmental impact: The reduction in the carbon footprint and the more sustainable approach to the CO₂ separation process with the GCM contribute to the preservation of the environment, which in turn positively affects the public health.
Improved workplace safety: Reduced need for frequent maintenance and more stable and predictable operations can improve the workplace safety, reducing the risk of accidents and injuries.
Regulatory compliance: Adopting safer and more sustainable technologies, such as the GCM, can help companies comply with environmental and health and safety regulations more easily, avoiding fines and penalties.

In summary, the use of the green ceramic membrane (GCM) not only offers economic advantages, but also contributes to improving the health and safety of workers, as well as reducing environmental impact, making it a safer and more sustainable option for the oil and gas industry.

### Reliability:

Chemical resistance: Unlike the polymeric membranes, the green ceramic membranes are highly resistant to aggressive chemicals, such as acids and bases. This chemical resistance ensures durability and long-term stability.
Long-term stability: The green ceramic membranes have a much higher long-term stability than the polymeric membranes. This means it maintains its effective performance over a much longer period without significant degradation, resulting in fewer interruptions and maintenance.
Resistance to plasticization: The polymeric membranes undergo plasticization in the presence of high CO₂ concentrations and high pressures, which can negatively affect their selectivities. The green ceramic membrane, due to its solid structure and strong chemical bonds, is not susceptible to the plasticization, ensuring consistent performance over time.
Backwash: The porous structure of the green ceramic membrane allows backwashing operations to be carried out to remove fouling and contaminants. This helps maintain the efficiency of the membrane and extend its service life, which is an important feature in terms of reliability.
Fewer operational shutdowns: Since the green ceramic membrane has a significantly longer service life and requires less maintenance, there is less need for operational shutdowns to replace membranes. This increases the reliability of the CO₂ separation process.
Resistance to extreme conditions: The green ceramic membrane can operate under more severe conditions, including high CO₂ concentrations, high pressures and high temperatures (above 200° C.), which is a significant advantage in challenging situations.
Waste reduction: The waste generated by the green ceramic membrane is 100% reusable in other industrial sectors, which not only reduces the environmental impact but also avoids the need for landfill disposal, contributing to a more sustainable approach.

In summary, the green ceramic membrane (GCM) of this invention offers greater reliability due to its chemical resistance, long-term stability, ability to withstand adverse conditions, non-susceptibility to plasticization and greater ease of maintenance. This results in a more robust CO₂ separation process, with fewer operational shutdowns and greater consistency in performance over time.

### Environmental Benefits

Longer service life: It is estimated that the green ceramic membrane can have a service life of over 20 years, much longer than the polymeric membranes, which generally last less than 5 years. Fewer membrane replacements over time means less waste production and less consumption of natural resources in the manufacture of new membranes.
Reusable waste: The waste from the green ceramic membranes can be fully reused in other industrial sectors, such as the ceramic industry, civil construction, paving and cement industry. This eliminates the need to dispose of waste in landfills and contributes to a more sustainable approach.
Reduced extraction of natural resources: Reusing waste from green ceramic membranes reduces the demand for natural raw materials, such as sand, gravel and limestone, which are often used in civil construction. This preserves natural resources and avoids environmental impacts associated with extraction, such as soil degradation and the destruction of biomes.
Lower energy consumption: The green ceramic membrane allows operation with lower pressure differences (ΔP) between the feed and the permeate compared to polymeric membranes. This reduces the need for high-powered compressors to raise the permeate pressure back to adequate levels. Less energy is consumed in this process, which reduces the emissions of carbon dioxide (CO₂) and other air pollutants associated with electricity generation.
Lower carbon footprint: The reduction in energy consumption and the lower generation of waste through the use of the green ceramic membrane contribute to a lower carbon footprint in the natural gas production chain.
Low environmental impact process: The manufacturing of the green ceramic membrane involves processing steps that produce fewer air pollutants and liquid effluents compared to more complex manufacturing processes, such as the production of synthetic polymers. This contributes to a lower environmental impact.

In short, the use of green ceramic membranes for separating CO₂ from the natural gas not only improves the process efficiency, but also contributes to reducing greenhouse gas emissions and the carbon footprint associated with the natural gas production. This sustainable approach is essential to mitigate the environmental impacts of the oil and gas industry, aligning with greenhouse gas emission reduction targets and promoting cleaner and more responsible energy production.

### Social Benefits

The use of the green ceramic membranes for separating CO₂ from natural gas offers a number of important social benefits, ranging from reducing greenhouse gas emissions to promoting economic and technological development, as well as improving public health and air quality. These benefits contribute to a more sustainable and resilient future in social and environmental terms.

1. A multilayer green sol-gel ceramic membrane, comprising:
(1) Ceramic support of micrometric particles of α-Al₂O₃;
(2) First intermediate layer of submicrometric particles of α-Al₂O₃;
(3) Second intermediate layer of nanometric particles of γ-Al₂O₃;
(4) Separation sublayer of mesoporous silica; and
(5) Final separation layer of microporous silica.

2. The ceramic membrane according to claim 1, wherein the ceramic support is composed of aluminum oxide in alpha crystalline phase, methyl cellulose 27.5-31.5%, deionized water and glycerol, and has an average pore size of 0.7-0.9 μm.

3. The ceramic membrane according to claim 1, wherein the first intermediate layer of submicrometric particles of α-Al₂O₃ is composed of aluminum oxide in alpha crystalline phase, deionized water, polyvinyl alcohol PVA 35%, carboxymethyl cellulose CMC 90% and carboxylic acid 65%, and has an average pore size of 80-100 nm.

4. The ceramic membrane according to claim 1, wherein the second intermediate layer of nanometric particles of γ-Al₂O₃ is composed of aluminum tri-sec-butoxide 97%, nitric acid, deionized water and polyvinyl alcohol PVA 35%, and has an average pore size of 4-20 nm.

5. The ceramic membrane according to claim 1, wherein the separation sublayer of mesoporous silica is composed of tetraethyl orthosilicate, hydrochloric acid, anhydrous ethanol, deionized water and triethylhexylammonium bromide, and has an average pore size of 2 nm.

6. The ceramic membrane according to claim 1, wherein the final separation layer of microporous silica is composed of tetraethyl orthosilicate, hydrochloric acid, anhydrous ethanol and deionized water, and has an average pore size of less than 0.4 nm.

7. The ceramic membrane according to claim 1, wherein the ceramic membrane has CO₂ gas permeance values of the order of 1.10×10⁻⁶ mol/m²·s·Pa.

8. The ceramic membrane according to claim 1, wherein the ceramic membrane presents mechanical strengths between 120 and 2960 bar (12 and 296 MPa) in a tubular geometry, and between 30 and 640 bar (3 and 64 MPa) in a flat geometry.

9. Use of the multilayer sol-gel green ceramic membrane, as defined in claim 1, for removing CO₂ from natural gas.

10. The use according to claim 9, further for capturing CO₂ from exhaust gas streams, allowing its subterrain storage or its use in industrial processes.

11. The use according to claim 9, further for direct capture of CO₂ from Earth's atmosphere for its subsequent use in different sectors of industry or geological storage.

12. The use according to claim 9, further for separating CO₂ from biogas.

13. The use according to claim 9, further for capturing CO₂ released during calcination of limestone and also gases exhausted during cement manufacturing process.

14. The use according to claim 9, further for obtaining and purifying CO₂ for preserving and freezing food or carbonating carbonated beverages.

15. The use according to claim 9, further for selectively separating CO₂ to be subsequently injected into planting greenhouses to improve crop growth, quality and yield.

16. The use according to claim 9, further for concentrating and supplying CO₂ directly to microorganisms, increasing efficiency of a fermentation process.
